(19) United States
(12) Patent Application Publication
(10) Pub. No.: US 2002/0105431 A1
(43) Pub. Date: Aug. 8, 2002

(54) Gift tag with motion-sensitive audio playback device

(76) Inventors: Keith F. McNeese, Ransom Canyon, TX (US); Lonnie F. Gary, Ransom Canyon, TX (US); Stephen L. Fillipp, Lubbock, TX (US); Andrew G. Avinger, Lubbock, TX (US)

Correspondence Address: Monty L. Ross, Locke Liddell & Sapp LLP, Suite 2200, 2200 Rose Avenue, Dallas, TX, 75201-6776, US

(21) Appl. No.: 09/779,224

(22) Filed: Feb. 8, 2001

(51) Int. Cl. G08B 25/08

(52) U.S. Cl. 340/692; 340/384.1

(57) ABSTRACT

A gift tag comprising a housing that is conveniently attachable to a gift and contains electronic circuitry that can be selectively activated to play a recorded soundtrack whenever the package and tag are moved following such activation. The gift tag housing preferably comprises two switches. The first switch is accessible from outside the housing and is selectively activated by the user whenever the gift is placed in a predetermined location. The second switch is a motion-activated switch disposed inside the housing that initiates operation of a playback circuit. The playback circuit desirably includes a direct current power supply, an electronic chip comprising a digital electronic memory device, a digital-to-analog converter and a speaker.

### BACKGROUND OF THE INVENTION

1. Field of the Invention

This invention relates to gift tags that, when activated, play an audible recording. More particularly, the invention disclosed herein relates to a tag that is selectively attachable to a gift and that comprises a motion sensor capable of activating an electronic circuit to play a short, prerecorded soundtrack whenever the gift is moved.

2. Description of Related Art

Novelty articles that can be selectively activated, such as by pushing a button, to play prerecorded messages are well known. More recently, articles have also been disclosed that contain so-called “motion sensors” that activate a playback circuit to play an audible sound, song or message stored in digital format in an electronic chip. In many such devices, the “motion sensors” are really photoelectric cells that are activated by a change in the light intensity reaching a receptor as an individual approaches or moves by the article. In other devices, mechanical motion sensors such as leaf switches are used in combination with electrical circuits to initiate or terminate a function whenever the device is subjected to certain types of motion.

Audio recording devices useful for recording personal messages have also been disclosed that can be attached, for example, to a refrigerator or message board.

### SUMMARY OF THE INVENTION

The invention disclosed herein, which represents a new use for previously known technology, is a gift tag comprising a housing that is conveniently attachable to a gift and contains electronic circuitry that can be selectively activated to play a prerecorded soundtrack whenever the package and tag are moved following such activation. The gift tag of the invention is desirably attachable to a gift using ribbon, string, or an adhesive pad or strip. The gift tag housing preferably comprises two switches. The first switch is conveniently accessible from outside the housing and is selectively activated by the user whenever the gift is placed in a predetermined location. The second switch is a motion-activated switch disposed inside the housing that initiates operation of the playback circuit. The playback circuit desirably includes an electronic chip further comprising a controller, a digital electronic memory device, a digital-to-analog converter and a speaker. The prerecorded soundtrack can comprise one or more musical passages, one or more verbal statements, one or more seasonal or occasional sound effects, or any combination of these. Exemplary prerecorded messages include the verbal statements, “Don't shake me!” or “Don't open me before Christmas!” According to one preferred embodiment of the invention, a microphone, an analog-to-digital converter and a digital storage circuit are also provided inside the gift tag housing to enable the user to record personal messages for playback whenever the gift is moved sufficiently to activate the playback circuit.

### BRIEF DESCRIPTION OF THE DRAWINGS

The apparatus of the invention is further described and explained in relation to the following figures of the drawings wherein:

FIG. 1 is a top plan view of a preferred embodiment of the gift tag of the invention;

FIG. 2 is a front elevation view of the gift tag of FIG. 1;

FIG. 3 is a bottom plan view of the gift tag of FIG. 1;

FIG. 4 is a cross-sectional view taken along line 4-4 of FIG. 1;

FIG. 5 is a cross-sectional view taken along line 5-5 of FIG. 1;

FIG. 6 is a cross-sectional view taken along line 6-6 of FIG. 1;

FIG. 7 is a cross-sectional view taken along line 7-7 of FIG. 1; and

FIG. 8 is a simplified diagrammatic view of the electronic components of the gift tag of FIG. 1.

Like reference numerals are used to indicate like parts in all figures of the drawings.

### DESCRIPTION OF THE PREFERRED EMBODIMENTS

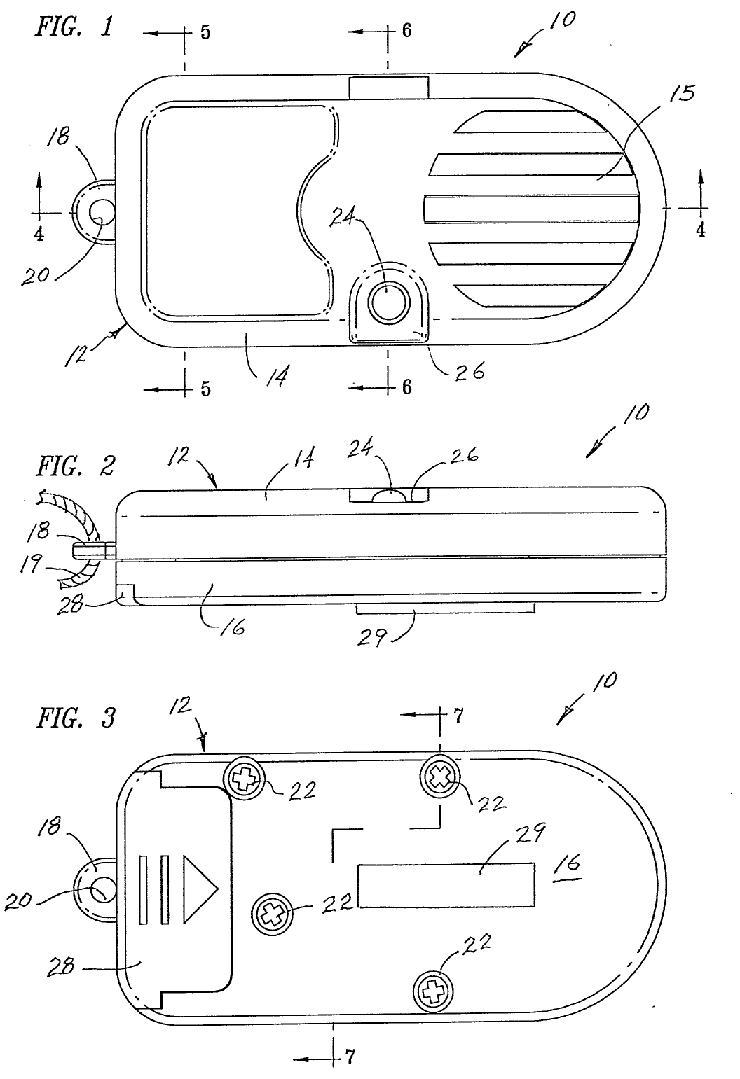

Referring to FIGS. 1-3, gift tag 10 of the invention preferably comprises housing 12 made of metal, fiberglass or a moldable thermoplastic resin and further comprises top section 14 and bottom section 16 that are joined to each other by screws 22 or by other similarly effective means. Cover 28 attached to bottom 16 is provided for use in covering the battery compartment as described below. Top 14 of housing 12 preferably further comprises a speaker grill section 15, on/off button or switch 24, and an integrally or unitarily formed loop 18 or other similarly effective means for attaching gift tag 10 to a gift. According to a particularly preferred embodiment, loop 18 is molded onto one end of top 14 and further comprises aperture 20 having a diameter sufficient to receive a length 19 of string, cord, ribbon, or the like, that is flexible enough to permit attachment of gift tag 10 to a gift. Alternatively, as shown only in FIGS. 2 and 3, a pressure sensitive adhesive pad or strip 29 can be provided for use in attaching gift tag 10 in place of a flexible connector passing through aperture 20 of loop 18, which is not then required.

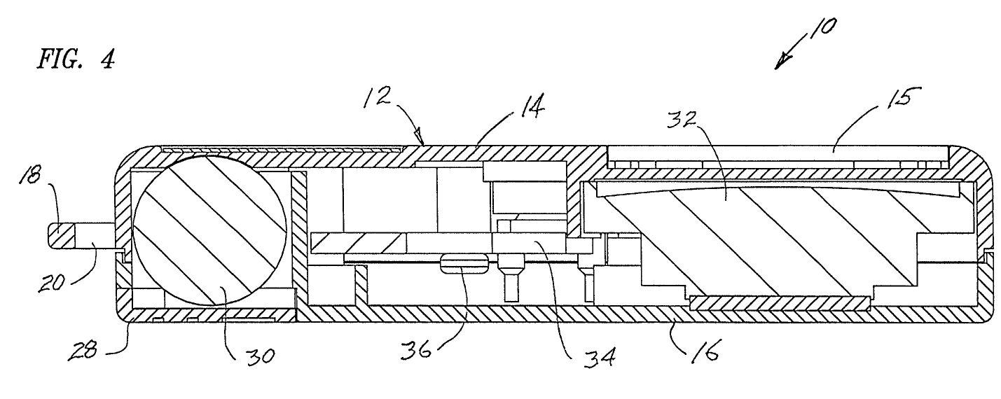

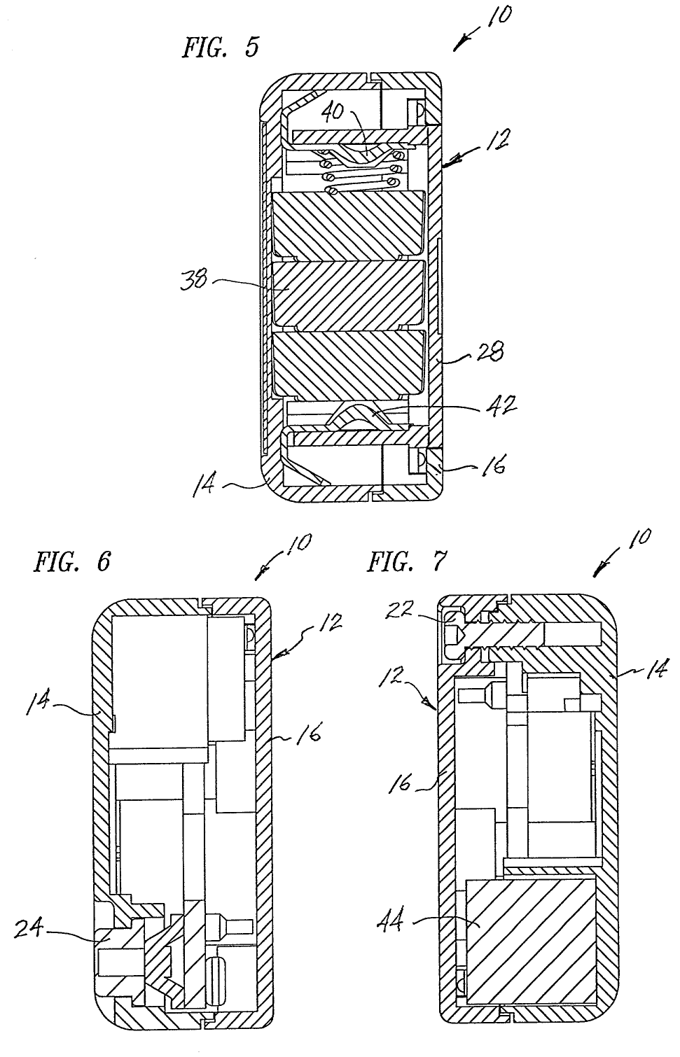

Referring to FIGS. 4-8, housing 12 preferably contains a direct current power supply such as battery 30, on-off switch or button 24, a motion switch or sensor 44, a speaker 32, and a printed circuit board 34 attached by means such as screw 36. Printed circuit board 34 preferably comprises commercially available “voice chip” circuitry, the electronic circuitry necessary to control operation of the device, including storing and reproducing a digital soundtrack that is converted to an analog signal and played through speaker 32 upon activation of the playback circuit. According to one embodiment of the invention, the soundtrack is prerecorded during manufacture and stored in digital format inside a storage element of printed circuit board 34. Such prerecorded soundtracks can include, for example, short musical selections, voice messages, sound effects and other audible sounds that are appropriate for a gift being given for a predetermined holiday, special event or occasion.

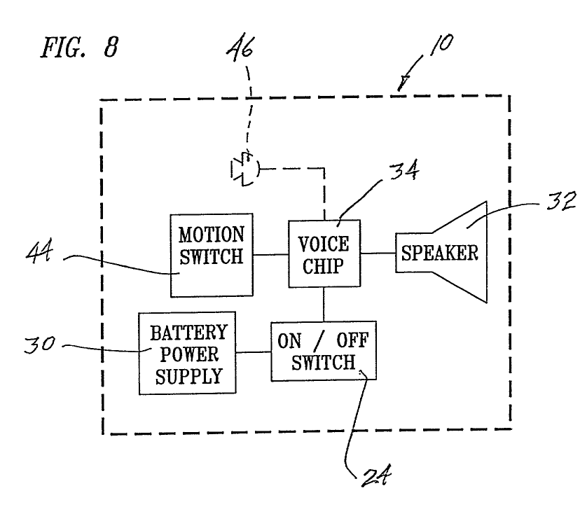

Once gift tag 10 has been attached to a gift and the gift has been placed in a desired location, on-off switch 24 is switched on, thereby activating motion sensor 44. If gift tag 10 is thereafter moved beyond minimal predetermined tolerances, motion sensor/switch 44 senses the movement and activates the audio playback circuit, causing the prerecorded soundtrack to play for a predetermined interval. Alternatively, as shown in FIG. 8, gift tag 10 can also include a microphone 46 that can be used to record a more personal message that is played whenever the gift to which it is attached is handled and moved, presumably by the recipient of the gift. Where gift tag 10 is adapted to permit the use of personalized audio messages or other recorded sounds, it will be appreciated by those of ordinary skill in the art that printed circuit board 34 will also comprise well known and commercially available electronic components such as an analog to digital converter and digital electronic memory component suitable for digitizing and electronically storing the audible sounds for playback upon activation of the playback circuit by motion sensor/switch 44 as before. Where both audio recording and playback capabilities are provided on printed circuit board 34, a multiple position switch 24 is preferred for differentiating among “on,” “off” and “record” positions.

Several types of motion sensor/switches 44 are commercially available and are satisfactory for use in gift tag 10 of the invention. One preferred motion sensor/switch 44 comprises a lightweight wire coil that is disposed around an electrical contact inside a sensor housing. Any significant movement of the sensor housing causes the coil to “sway,” touching the electrical contact inside the coil and signaling printed circuit board 34 to activate the playback circuit.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A gift tag comprising:
a housing further comprising an element attachable to a gift;
electronic circuitry disposed inside the housing, the electronic circuitry further comprising first and second switches, a direct current power supply, and an audio playback circuit;
said first switch being accessible from outside the housing and having selectable on and off positions;
said second switch being a motion-sensitive switch that is triggered to activate the audio playback device whenever the gift is moved beyond predetermined limits while the first switch is in the on position; and
at least one digitized audio soundtrack playable by the audio playback circuit whenever the audio playback circuit is activated.

2. The gift tag of claim 1 wherein the element is a loop molded as part of the housing.

3. The gift tag of claim 1 wherein the element is an adhesive pad.

4. The gift tag of claim 1 wherein the element is an adhesive strip.

5. The gift tag of claim 1 wherein the direct current power supply is a battery.

6. The gift tag of claim 1 wherein the audio playback circuit comprises a digital electronic memory component, a digital-to-analog converter and a speaker.

7. The gift tag of claim 1, further comprising an audio recording circuit.

8. The gift tag of claim 7 wherein the audio recording circuit comprises a microphone, an analog-to-digital converter and a digital electronic memory component.

9. The gift tag of claim 1 wherein the digitized audio soundtrack includes at least one musical selection.

10. The gift tag of claim 1 wherein the digitized audio soundtrack includes at least one verbal statement.

11. The gift tag of claim 1 wherein the digitized audio soundtrack includes at least one seasonal sound effect.
